(19) United States
(12) Patent Application Publication
(10) Pub. No.: US 2025/0378336 A1
(43) Pub. Date: Dec. 11, 2025

(54) LIGHTWEIGHT CODEWORD MODEL FOR EDGE OPERATION USING AN ALL-BINARY CORE

(71) Applicant: AtomBeam Technologies Inc., Moraga, CA (US)

(72) Inventor: Brian Galvin, Silverdale, WA (US)

(21) Appl. No.: 18/890,788

(22) Filed: Sep. 20, 2024

Related U.S. Application Data
(63) Continuation-in-part of application No. 18/737,906, filed on Jun. 7, 2024.

(51) Int. Cl. G06N 3/084

(52) U.S. Cl. CPC G06N 3/084

(57) ABSTRACT

An all-binary neural network system and method for processing and analyzing multi-source time series data is disclosed. The system employs a shared codebook to encode input streams into binary codewords, which are then processed through a series of binary convolutional layers, binary LSTM layers, and binary fully connected layers. The system maintains binary representations throughout, enabling efficient computation and reduced memory requirements while effectively capturing temporal and inter-source relationships in the data.

### CROSS-REFERENCE TO RELATED APPLICATIONS

Priority is claimed in the application data sheet to the following patents or patent applications, each of which is expressly incorporated herein by reference in its entirety:
Ser. No. 18/737,906

### BACKGROUND OF THE INVENTION

### Field of the Art

The present invention relates to the field of artificial intelligence and machine learning, and more particularly to neural network architectures and their applications in data processing and analysis.

### Discussion of the State of the Art

In recent years, the field of artificial intelligence and machine learning has seen significant advancements, particularly in the area of neural networks. These powerful computational models have demonstrated remarkable capabilities in processing and analyzing complex data, including time series data from multiple sources. However, as the complexity and scale of these models have grown, so too have their computational and memory requirements, presenting challenges for deployment in resource-constrained environments such as edge devices and IoT sensors.

Traditional neural network architectures, including convolutional neural networks (CNNs) and long short-term memory (LSTM) networks, typically operate using floating-point arithmetic. While effective, these floating-point operations are computationally expensive and require significant memory bandwidth. This limitation becomes particularly acute when dealing with high-dimensional time series data from multiple sources, where real-time processing and low latency are often critical requirements.

Furthermore, the increasing need for privacy-preserving computation and the growing concerns over data security have highlighted the importance of developing more efficient and secure methods for data processing and analysis. Traditional neural networks, with their reliance on floating-point arithmetic, can be vulnerable to various attacks and may not be suitable for use in highly secure or privacy-sensitive applications.

Efforts to address these challenges have led to the development of quantized neural networks, where weights and activations are represented using lower-precision formats. While these approaches offer some improvements in computational efficiency and memory usage, they still rely on multi-bit representations and do not fully leverage the potential efficiency gains of truly binary computations.

Additionally, existing approaches often struggle to effectively handle multi-source time series data, where the relationships between different data streams can be as important as the patterns within each individual stream. The ability to capture and analyze these inter-stream relationships while maintaining computational efficiency remains a significant challenge.

There is, therefore, a pressing need for a neural network architecture that can efficiently process and analyze multi-source time series data while operating within the constraints of edge computing environments. Such a system should ideally maintain binary representations throughout its operations, from initial data encoding to final output generation, to maximize computational efficiency and minimize memory requirements. Furthermore, it should be capable of capturing both temporal dependencies within individual data streams and relationships between multiple data sources, all while maintaining the speed and efficiency necessary for real-time applications.

What is needed is a system and method which addresses these needs by introducing an all-binary neural network system specifically designed for multi-source time series analysis and anomaly detection. By leveraging binary representations and operations throughout the entire processing pipeline, from input encoding to output generation, this system offers significant advantages in terms of computational efficiency, memory usage, and potential for secure computation, while maintaining the ability to capture complex patterns and relationships in multi-source time series data.

### SUMMARY OF THE INVENTION

Accordingly, the inventor has conceived and reduced to practice, an all-binary neural network system and method for processing and analyzing multi-source time series data. The system employs a shared codebook to encode input streams into binary codewords, which are then processed through a series of binary convolutional layers, binary LSTM layers, and binary fully connected layers. The system maintains binary representations throughout, enabling efficient computation and reduced memory requirements while effectively capturing temporal and inter-source relationships in the data.

According to a preferred embodiment, a system for processing data using an all-binary neural network is disclosed, comprising: a computing device comprising at least a memory and a processor: an all-binary core comprising a first plurality of programming instructions stored in the memory and operable on the processor, wherein the first plurality of programming instructions, when operating on the processor, cause the computing device to: encode input data into binary codewords; process the binary codewords through a plurality of binary neural network layers; generate a final output using the processed binary codewords; and maintain binary representations and operations throughout the neural network.

According to another preferred embodiment, a method for processing data using an all-binary neural network is disclosed, comprising the steps of: encoding input data into binary codewords; processing the binary codewords through a plurality of binary neural network layers; generating a final output using the processed binary codewords; and maintaining binary representations and operations throughout the neural network.

According to an aspect of an embodiment, encoding input data into binary codewords comprises using a shared codebook.

According to an aspect of an embodiment, the shared codebook uses Huffman coding to generate binary codewords for input data values.

According to an aspect of an embodiment, the plurality of binary neural network layers comprises one or more binary convolutional layers.

According to an aspect of an embodiment, the binary convolutional layers comprise:

binary weights; binary activation functions; and operations implemented using XNOR and popcount functions.

According to an aspect of an embodiment, further comprising a binary max pooling layer following at least one of the binary convolutional layers.

According to an aspect of an embodiment, the plurality of binary neural network layers comprises one or more binary long short-term memory (LSTM) layers.

According to an aspect of an embodiment, the binary LSTM layers comprise: binary input, forget, and output gates; a binary cell state; and binary matrix multiplications implemented using XNOR and popcount functions.

According to an aspect of an embodiment, the plurality of binary neural network layers comprises one or more binary fully connected layers.

According to an aspect of an embodiment, wherein the binary fully connected layers comprise: binary weights; binary activation functions; and binary matrix multiplications implemented using XNOR and popcount functions.

According to an aspect of an embodiment, the input data comprises multi-source time series data.

According to an aspect of an embodiment, the final output comprises a binary anomaly indicator.

According to an aspect of an embodiment, the one or more hardware processors are further configured for training the all-binary neural network by: initializing binary weights for the neural network layers; forward propagating binary codewords through the network while maintaining binary representations; computing a loss function based on the network's binary output; back-propagating errors through the network using binary approximations of gradients; and updating binary weights using a binary optimization algorithm.

According to an aspect of an embodiment, the one or more hardware processors are further configured for quantizing floating-point values to binary or n-bit integer representations.

According to an aspect of an embodiment, the all-binary neural network is implemented on an edge computing device with limited computational and memory resources.

### BRIEF DESCRIPTION OF THE DRAWING FIGURES

FIG. 1A is a block diagram illustrating an exemplary system architecture for an all-binary model core for a Lightweight Codeword Model Core.

FIG. 1B is a block model illustrating an aspect of a system for an all-binary model for deep learning, a data preprocessor.

FIG. 1C is a block model illustrating an aspect of a system for providing a lightweight codeword model, an all-binary model subsystem, which serves as the central processing unit responsible for learning the underlying patterns, relationships, and dependencies within the input data.

FIG. 1D is a block model illustrating an aspect of a system for providing a lightweight codeword model, a data post processor.

FIG. 2 is a block diagram illustrates an exemplary pipeline for processing a plurality of input streams from a plurality of input sources using an all-binary model, according to an embodiment.

FIG. 3A is a block diagram illustrating an exemplary aspect of an all-binary model, the convolutional phase of the all-binary model.

FIG. 3B is a block diagram illustrating an exemplary aspect of an all-binary model, the LSTM and FCN phase of the all-binary model.

FIG. 4 is a diagram illustrating an exemplary neural network neuron, configured to operate as a binary neuron according to an embodiment.

FIG. 5 is a block diagram illustrating a codebook generation system configured to operate in a cloud-based environment and create a shared codebook from a plurality of input sources associated with a complex system.

FIG. 6 is a block diagram illustrating an aspect of a system for providing an all-binary model core for a lightweight codeword model, a machine learning training system.

FIG. 7 is a flow diagram illustrating an exemplary method for creating a shared codebook for encoding input data streams into a codeword stream, according to an aspect.

FIG. 8 is a flow diagram illustrating an exemplary method for processing a vector of codewords using an all-binary model, according to an aspect.

FIG. 9 is a flow diagram illustrating an exemplary method for anomaly detection using an all-binary model, according to an aspect.

FIG. 10 illustrates an exemplary computing environment on which an embodiment described herein may be implemented.

### DETAILED DESCRIPTION OF THE INVENTION

The inventor has conceived, and reduced to practice, an all-binary neural network system and method for processing and analyzing multi-source time series data. The system employs a shared codebook to encode input streams into binary codewords, which are then processed through a series of binary convolutional layers, binary LSTM layers, and binary fully connected layers. The system maintains binary representations throughout, enabling efficient computation and reduced memory requirements while effectively capturing temporal and inter-source relationships in the data.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “machine learning core” refers to the central component responsible for processing and learning from the codeword representations derived from the input data. This core can consist of one or more machine learning architectures, working individually or in combination, to capture the patterns, relationships, and semantics within the codeword sequences. Some common architectures that can be employed in the machine learning core of include but are not limited to transformers, variational autoencoders (VAEs), recurrent neural networks (RNNs), convolutional neural networks (CNNs), and attention mechanisms. Some common architectures that can be employed in the machine learning core of all-binary models include but are not limited to convolution networks, long short-term memory networks, and fully connected networks. These architectures can be adapted to operate directly on the codeword representations, with or without the need for traditional dense embedding layers. The machine learning core learns to map input codeword sequences to output codeword sequences, enabling tasks such as language modeling, text generation, prediction, anomaly detection, and classification.

As used herein, “codeword” refers to a discrete and compressed representation of a sourceblock, which is a meaningful unit of information derived from the input data. Codewords are assigned to sourceblocks based on a codebook generated by a codebook generation system. The codebook contains a mapping between the sourceblocks and their corresponding codewords, enabling efficient representation and processing of the data. Codewords serve as compact and encoded representations of the sourceblocks, capturing their essential information and characteristics. They are used as intermediate representations within an all-binary lightweight codeword model system, allowing for efficient compression, transmission, and manipulation of the data.

### Conceptual Architecture

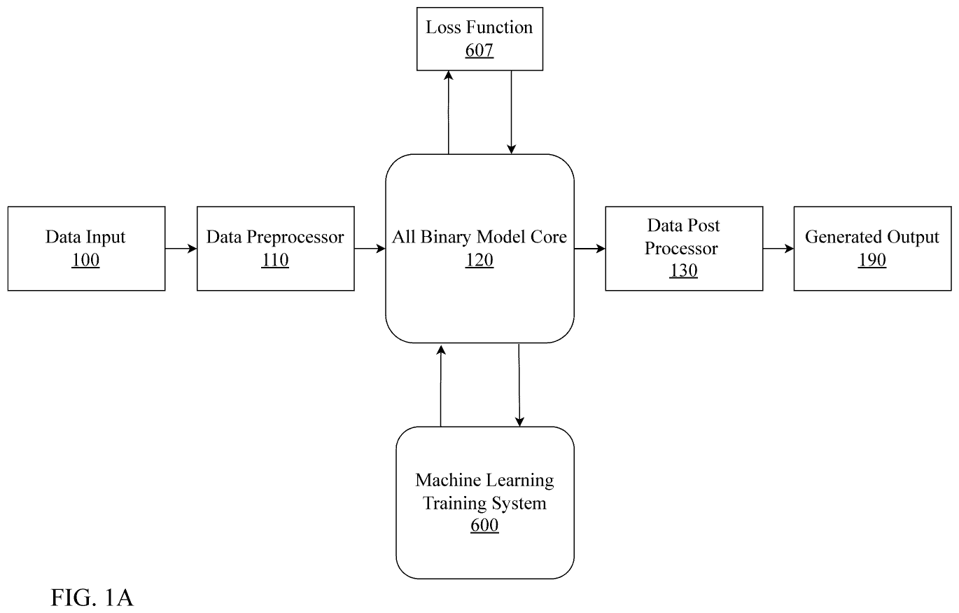

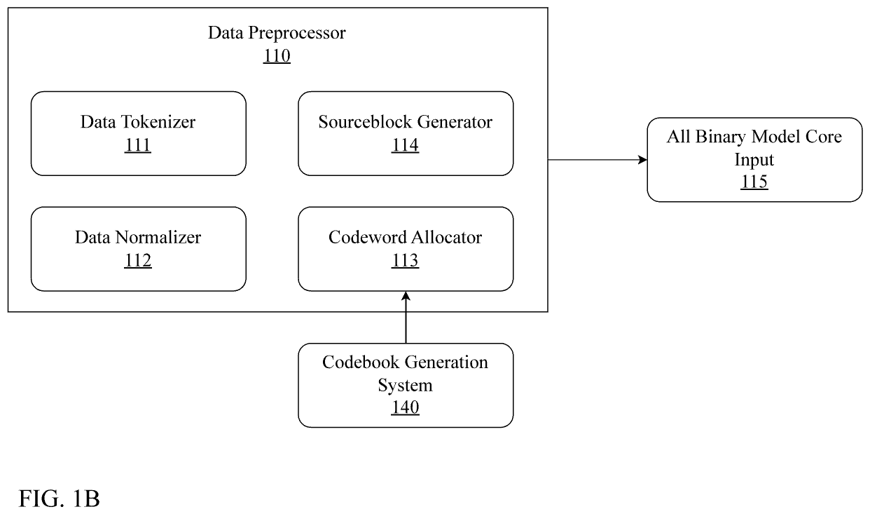

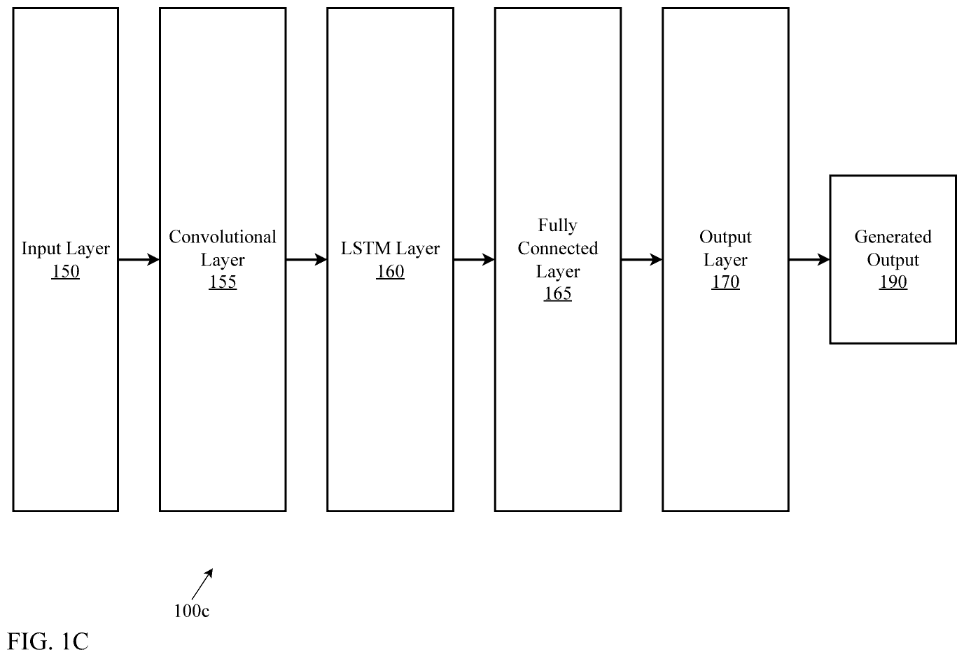

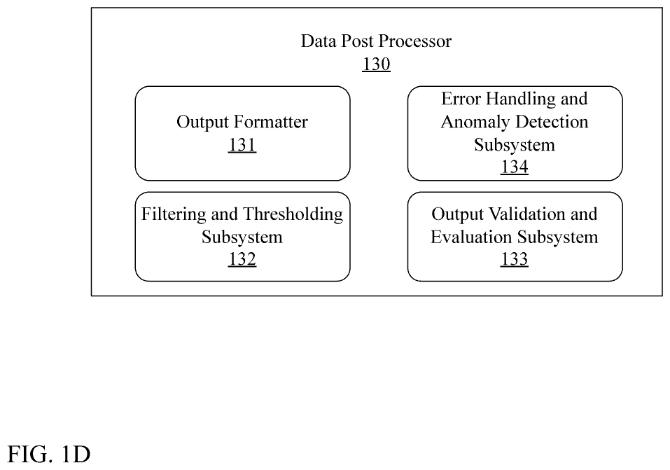

FIG. 1A is a block diagram illustrating an exemplary system architecture for an all-binary model core for a lightweight codeword model core. The attached figure presents a streamlined view of the all-binary model core system, focusing on the core components and their interactions. This simplified representation highlights the essential elements of the system and illustrates the flow of data from input to output, along with the training process that enables the system to learn and generate meaningful results. In an embodiment, the all-binary model may be implemented on an edge computing device with limited computational and memory resources.

The system is fed a data input 100, which represents the raw data that needs to be processed and analyzed. This data can come from various sources and domains, such as time series, text, images, or any other structured or unstructured format. In an exemplary embodiment, input data 100 may comprise a plurality of time-series data obtained from a plurality of sensors associated with a complex system. A particular use case can be directed to complex system represented as a combine harvester outfitted with a plurality of sensors/sensor arrays which may be correlated in one or more aspects. For instance, combine harvester sensor data may be correlated temporally wherein the plurality of sensor measurements/outputs (i.e., input data 100) are correlated with each other using time stamps which indicate a subset of the plurality of measurements were obtained in the same or similar time frame. Additionally, or alternatively, combine harvester sensors data may be correlated based on the component or subsystem of the harvester on which they are deployed such as sensors deployed to monitor the operation of the harvester's engine, such as oil pressure, engine temperatures, cylinder timing, and distributor firing timing data, to name a few. Some examples of sensor readouts from a combine harvester can include, but are not limited to, engine RPM sensor which provides time-series data of engine rotations per minute; grain loss sensor which provides percentage of grain loss over time; yield monitor which provides crop yield in bushels or tons per acre/hectare over time; moisture sensor which provides a percentage of moisture content in harvested grain over time; fuel level sensor which provides the remaining fuel volume over time; hydraulic pressure sensor which provides pressure readings in various hydraulic systems over time; header height sensors which provides the distance between header and ground over time (correlates with optime cutting height, terrain variations, and potential obstacles); threshing drum speed which provides rotations per minutes of the threshing drum over time; sieve opening sensor which provides the gap width of cleaning sieves over time; global positioning system (GPS) position sensor which provides latitude and longitude coordinates over time; accelerometer which provides vibration levels in different parts of the harvester over time; and temperature sensors (multiple locations) which provide temperature readings from various components over time. These sensor readouts, when analyzed together, can provide valuable insights into the harvester's performance, crop conditions, and field characteristics. They can be used for real-time adjustments, predictive maintenance, and long-term agricultural planning. The data input 100 is fed into a data preprocessor 110, which is responsible for cleaning, transforming, and preparing the data for further processing. Data preprocessor 110 may perform tasks such as normalization, feature scaling, missing value imputation, or any other necessary preprocessing steps to ensure the data is in a suitable format for machine learning core 120.

Once the data is preprocessed, it is passed to an all-binary model, machine learning core 120 which stores and operates a lightweight codeword model(s). Machine learning core 120 may employ advanced techniques such as self-attention mechanisms and multi-head attention to learn the intricate patterns and relationships within the data. It may operate in a latent space, where the input data is encoded into a lower-dimensional representation that captures the essential features and characteristics. By working in this latent space, machine learning core 120 can efficiently process and model the data, enabling it to generate accurate and meaningful outputs. In some embodiments, all-binary model core 120 may utilize deep learning techniques to generate a latent representations of the input data.

The generated outputs from the machine learning core 120 are then passed through a data post processor 130. Data post processor 130 is responsible for transforming the generated outputs into a format that is suitable for the intended application or user. It may involve tasks such as denormalization, scaling back to the original data range, or any other necessary post-processing steps to ensure the outputs are interpretable and usable.

The processed outputs are provided as a generated output 190, which represents the final result of the all-binary model system. The generated output 190 can take various forms, depending on the specific task and domain. It could be predicted values for time series forecasting, anomaly classifications, generated text for language modeling, synthesized images for computer vision tasks, or any other relevant output format.

To train and optimize all-binary model core 120, the system includes a machine learning training system 600. The training system 600 is responsible for updating the parameters and weights of machine learning core 120 based on the observed performance and feedback. The training system 600 obtains outputs from the machine learning core 120 and processes the outputs to be reinserted back through the machine learning core 120 as a testing and training data set. After processing the testing and training data set, machine learning core 120 may output a testing and training output data set. This output may be passed through a loss function 607. The loss function 607 may be employed to measure the discrepancy between the generated outputs and the desired outcomes. The loss function 607 quantifies the error or dissimilarity between the predictions and the ground truth, providing a signal for the system to improve its performance. The training process is iterative, where the system generates outputs, compares them to the desired outcomes using the loss function 607, and adjusts the parameters of the machine learning core 120 accordingly.

Through the iterative training process, all-binary model core 120 learns to capture the underlying patterns and relationships in the data, enabling it to generate accurate and meaningful outputs. The training process aims to minimize the loss and improve the system's performance over time, allowing it to adapt and generalize to new and unseen data.

FIG. 1B is a block model illustrating an aspect of a system for an all-binary model for deep learning, a data preprocessor. The data preprocessor 110 plays a role in preparing the input data for further processing by all-binary machine learning core 120. It consists of several subcomponents that perform specific preprocessing tasks, ensuring that the data is in a suitable format and representation for effective learning and generation.

Data preprocessor 110 receives the raw input data and applies a series of transformations and operations to clean, normalize, and convert the data into a format that can be efficiently processed by the subsequent components of the system. The preprocessing pipeline can include but is not limited to subcomponents such as a data tokenizer, a data normalizer, a codeword allocator, and a sourceblock generator. A data tokenizer 111 is responsible for breaking down the input data into smaller, meaningful units called tokens. The tokenization process varies depending on the type of data being processed. For textual data, the tokenizer may split the text into individual words, subwords, or characters. For time series data, the tokenizer may divide the data into fixed-length windows or segments. The goal of tokenization is to convert the raw input into a sequence of discrete tokens that can be further processed by the system.

A data normalizer 112 is responsible for scaling and normalizing the input data to ensure that it falls within a consistent range. Normalization techniques, such as min-max scaling or z-score normalization, may be applied to the data to remove any biases or variations in scale. Normalization helps in improving the convergence and stability of the learning process, as it ensures that all features or dimensions of the data contribute equally to the learning algorithm. A codeword allocator 113 assigns unique codewords to each token generated by the data tokenizer 111. Additionally, codewords may be directly assigned to sourceblocks that are generated from inputs rather than from tokens. The codewords are obtained from a predefined codebook, which is generated and maintained by a codebook generation system 140. The codebook contains a mapping between the tokens and their corresponding codewords, enabling efficient representation and processing of the data. Codeword allocator 113 replaces each token, sourceblock, or input with its assigned codeword, creating a compressed and encoded representation of the input data. In some aspects, the conversion of raw data, tokens, or sourceblocks to codewords can be considered a form of data quantization. In some embodiments, codebook generation system 140 may be implemented as a cloud-based service which receives a plurality of training data (e.g., a plurality of time series data obtained from sensors associated with one or more complex systems) from various sources, creates a codebook associated with the plurality of training data, and then uses the created codebook to assign codewords and/or distributes the created codebook to one or more systems which handle the data conversion to codewords. For instance, a midserver or similar may be configured to use a stored codebook to encode obtained sensor data, or an edge device may be deployed with a codebook to encode obtained sensor data.

A sourceblock generator 114 combines the codewords assigned by the codeword allocator 113 into larger units called sourceblocks. Sourceblocks can be formed by grouping together a sequence of codewords based on predefined criteria, such as a fixed number of codewords or semantic coherence. The formation of sourceblocks helps in capturing higher-level patterns and relationships within the data, as well as reducing the overall sequence length for more efficient processing by all-binary model machine learning core 120.

Codebook generation system 140 is a component that can be configured to work in conjunction with data preprocessor 110. It is responsible for creating and maintaining the codebook used by codeword allocator 113. The codebook may be generated based on the statistical properties and frequency of occurrence of the tokens in the training data. In some aspects, the codebook may be associated with a data quantization process. The basic idea of quantization is to map a continuous range of values to a discrete set of values. For n-bit integer representation, the system can map floating-point values (e.g., sensor readings/output) to integers in the range [−(2 \hat{ }(n−1)), 2\hat{ }(n−1)-1].

In an embodiment, wherein Huffman coding is used, codebook generation system 140 aims to assign shorter codewords to frequently occurring tokens and longer codewords to rare tokens, optimizing the compression and representation of the data. Huffman coding is typically used for lossless data compression, but may be adapted for quantization. The Huffman process can analyze the distribution of values in the dataset (e.g., 64 input streams of time series data) and create a Huffman tree based on the frequency of values. It then assigns binary codes to each value based on the Huffman tree. It uses these binary codes as the quantized representation. The Huffman coding method is interpretable and can be very efficient for data with a known, stable distribution.

In an embodiment, a deep learning method of codeword generation may be implemented. In such an embodiment, codebook generation system 140 can use an autoencoder to learn an optimal quantization scheme. The encoder learns to map input values to discrete representations, while the decoder learns to reconstruct the original values. This method learns a non-linear quantization scheme that adapts to the data distribution. In an embodiment, a term may be added in the loss function which encourages the quantized values to be close to −1 or 1, making them easier to represent with fewer bits. In some implementations, the deep learning method comprises a latent transformer model. The deep learning method can learn more complex, non-linear quantization schemes and adapt to changing data distributions.

After the data has undergone the preprocessing steps performed by data preprocessor 110, the resulting output is the all-binary model core input 115. The all-binary model input 115 represents the preprocessed and encoded data that is ready to be fed into all-binary model learning core 120 for further processing and learning.

When dealing with time series prediction, codeword allocator 113 may take a sequence of time series data points as input. In one example the input sequence consists of 1000 data points. Codeword allocator 113 performs the necessary data preparation steps to create a suitable input vector for the autoencoder. It truncates the last 50 data points from the input sequence, resulting in a sequence of 950 elements. This truncated sequence represents the historical data that will be used to predict the future values. Codeword allocator 113 then creates a 1000-element vector, where the first 950 elements are the truncated sequence, and the last 50 elements are filled with zeros. This input vector serves as the input to variational autoencoder encoder subsystem 150, which compresses the data into a lower-dimensional latent space representation.

Codeword allocator 113 may split the incoming data input 100 into meaningful units called sourceblocks. This process, known as semantic splitting, aims to capture the inherent structure and patterns in the data. The allocator 113 may employ various techniques to identify the optimal sourceblocks, such as rule-based splitting, statistical methods, or machine learning approaches. In one embodiment, codeword allocator 113 may utilize Huffman coding to split the data into sourceblocks. The Huffman coding-based allocator enables efficient and semantically meaningful splitting of the input data into sourceblocks. Huffman coding is a well-known data compression algorithm that assigns variable-length codes to symbols based on their frequency of occurrence. In the context of the lightweight codeword model, the Huffman coding-based allocator adapts this principle to perform semantic splitting of the input data.

After the sourceblock generation process, codeword allocator 113 assigns a unique codeword to each sourceblock. The codewords are discrete, compressed representations of the sourceblocks, designed to capture the essential information in a compact form. Codeword allocator 113 can use various mapping schemes to assign codewords to sourceblocks, such as hash functions, lookup tables, or learned mappings. For example, a simple approach could be to use a hash function that maps each sourceblock to a fixed-length binary code. Alternatively, another approach may involve learning a mapping function that assigns codewords based on the semantic similarity of the sourceblocks.

Codebook generation subsystem 140 is responsible for creating and maintaining the codebook, which is a collection of all the unique codewords used by the all-binary lightweight codeword model. The codebook can be generated offline, before the actual processing begins, or it can be updated dynamically as new sourceblocks are encountered during processing. The codebook generation subsystem can use various techniques to create a compact and efficient codebook, such as frequency-based pruning, clustering, or vector quantization. The size of the codebook can be adjusted based on the desired trade-off between compression and information preservation. Using an example vector of grain loss percentage readings taken at 5-second intervals over a 1-minute period: grain_loss_readings=[0.8, 0.7, 0.9, 1.2, 1.5, 1.8, 2.1, 1.9, 1.7, 1.4, 1.1, 0.9] may be given codewords such as [12, 5, 78, 5, 21, 143, 92, 8, 201, 45, 17, 78], where each sourceblock (sensor reading) is assigned a unique codeword, which is represented as an integer. In this example, the values represent the percentage of grain loss in the range of 0.7% to 2.1%. This data could indicate an initial period of relatively low grain loss (0.7% to 00.9%); a sudden increase in grain loss, peaking at 2.1% at the 30-second mark; and a gradual decrease in grain loss towards the end of the minute. Such a pattern might correlate with factors such as changes in crop density, variation is harvester speed, adjustments to the threshing mechanism, or encountering a patch of overly dry or damp crop. The mapping between tokens (e.g., time series sensor readings) and codewords is determined by the codebook generated by the all-binary core lightweight codeword model.

The modular design of the system enables each subsystem to be trained independently or jointly, depending on the specific requirements and available resources. The machine learning training system 600 may provide the necessary mechanisms to optimize the performance of each component and ensure the overall effectiveness of the all-binary model lightweight codeword model.

FIG. 1C is a block model illustrating an aspect of a system for providing an all-binary lightweight codeword model, an all-binary model subsystem 100c, which serves as the central processing unit responsible for learning the underlying patterns, relationships, and dependencies within the input data. According to the embodiment, the all-binary lightweight codeword model subsystem 100c leverages advanced techniques such as convolutional layers 155, long short-term memory (LSTM) layers 160, and fully connected layers 165, to produce generated output 190 which can be used for various tasks such as, for example, anomaly detection or prediction. Other network architectures may be used in different embodiments.

The input to the all-binary model 100c is provided by an input layer 150. The input layer 150 is responsible for several functions. It receives input data such as, for example, 64-wide vectors of binary codewords, where each codeword represents a single timestamp reading from one of 64 sensors associated with a complex system (e.g., a combine harvester). The input layer ensures that the incoming data is properly formatted as binary numbers, ready for processing by the subsequent layers. It can provide the initial representation of the sensor data to the model, preserving the binary nature of the codewords. It may also manage the dimensionality of the input, maintaining the structure of the 64 (or other) separate input streams. For time series data, it handles the sequential nature of the inputs, potentially buffering or windowing the data as needed. While not explicitly part of the input layer, it interfaces with the codebook system that translates the original sensor readings into binary codewords using the predefined codebook (e.g., from Huffman coding or deep learning network). Depending on the specific implementation, it may perform some initial preprocessing or normalization of binary inputs. It feeds the formatted binary input data into the subsequent layers of the network (e.g., binary convolutional layers). The input layer essentially acts as the bridge between the raw sensor data (in its binary codeword form) and the internal processing of the neural network, ensuring that the data enters the system in a format that maintains its binary nature while preserving the structure and meaning of the, for example, 64 sensor streams.

The input layer 150 feeds into one or more convolutional layers 155. The convolutional layers may be implemented as specialized binary convolution layers. These layers can operate on the binary inputs and use binary weights, with operations optimized for binary computations. The convolutional layers 155 can accept binary inputs, which in some embodiments are binary codewords representing sensors readings. The weights in these layers can be represented as binary numbers (e.g., 8-bit integers as described herein, ranging from −128 to +127). Instead of floating-point multiplications, these layers can use bitwise operations for efficiency. For example, multiplication could be implemented using bit shifting and addition. In some embodiments, the outputs of these layers may also be quantized to maintain the binary nature of the network.

In embodiments where the input data comprises time series data from a plurality (e.g., 64 or any other number) of sensors, the network may be implemented as 1D convolution that operated across the time dimension for each sensor stream. The convolution layers can be designed to handle multiple input channels (64 in this exemplary case, one for each sensor stream) and can output multiple channels as well. The convolution kernels (filters) are binary, sliding across the input to detect patterns in the time series data. The convolutional layers may use concepts like stride and padding, but implemented in a way that preserves the binary nature of the computations. In aspects where pooling is used, it may be adapted to work with binary representations, for example, using operations like bitwise OR for max pooling.

In an embodiment, for maximum efficiency, these convolutional operations may be implemented at a lower level, for example, using custom CUDA kernels or specific hardware instructions optimized for binary operations. The convolution layers in this all-binary model would be responsible for extracting features from the time series data, detecting patterns and correlations across the 64 sensor streams, while maintaining the binary nature of the computations throughout the process.

In an embodiment, binary convolutional layer 155 outputs a tensor of binary (or quantized integer) values. For instance, the output shape may be of the form (batch_size, num_channels, sequence_length). Before feeding into the LSTM layer 160, the convolutional output may be reshaped to (batch_size, sequence_length, num_channels), which is a typical input format for LSTM layers.

The LSTM layer 160 itself may be modified to work with binary inputs and weights. An example of a binary LSTM layer may be implemented as follows: input, hidden, and cell states are all represented as binary or quantized integer values; gates (input, forget, output) use binary weights and binary activation functions; cell state update utilized binary operations instead of floating-point arithmetic; and the output computation may also be quantized to maintain the binary representation. In an embodiment, activation functions such as sigmoid or tanh may be approximated with binary operations. The LSTM may process the sequence step by step, maintaining the temporal nature of the data. This approach allows the model to process the sensor data through convolutional layers to extract features, and then use the LSTM to capture temporal dependencies in these features, all while maintaining a binary representation throughout the network.

In the all-binary model 100c, the fully connected layer 165 (FCN) that follows the LSTM layer 160 is configured to maintain the binary nature of the computations. The input to the FCN is the binary/quantized output from the LSTM layer. This may typically be a tensor, for example, of shape (batch_size, sequence_length, Istm_hidden_size). The weights in the FCN are binary numbers, represented as n-bit integers (e.g., 8-bit integers ranging from −128 to 127). In embodiments where biases are used, the biases are also represented as binary or quantized values. Instead of standard floating-point matrix multiplication, the FCN can use binary matrix multiplication. This can be implemented, for example, using bit-wise operations and population count functions for efficiency. The activation function is also implemented as a binary or quantized function. Some exemplary activation functions which may be implemented can include, but are not limited to, step function (binary), quantized ReLU, and quantized sigmoid or tanh. According to an aspect, the FCN may have multiple layers, each followed by a binary activation function. The final output 190 of the FCN (and thus the entire model) is a binary or quantized representation, which could then be interpreted based on the specific task (e.g., classification, regression).

The output layer 170 in the all-binary model produces the final result while maintaining the binary nature of the computations. Its primary function includes performing the last set of computations on the binary representations form the previous layer (typically the fully connected network). The output layer can be designed to produce results specific to the task at hand. For example, for classification it might output binary codes representing different classes, for regression it could produce a quantized value within a predetermined range, or for anomaly detection it might output a binary decision (normal/anomaly) or a quantized score. If the previous layers produce multi-bit outputs, output layer 170 may further quantize these to maintain the binary nature of the model, according to an aspect. The output layer provides a representation that can be easily interpreted or translated back into meaningful results. It may apply scaling factors to the binary outputs to map them to the desired output range. It may apply a final activation function, such as a step function for binary classification or a quantized sigmoid for multi-class problems. The role of output layer 170 is important because it bridges the gap between the binary computations inside the model and the interpretable results needed for the specific task. It ensures that the final output 190 maintains the efficiency and compactness of binary representations while still providing meaningful and usable results for the given application, such as classifying unusual events in the 64-channel sensor data.

The specific architectures and parameters of the all-binary model can be customized and adapted based on the characteristics and requirements of the input data and the specific task at hand. The modular design of the system allows for flexibility and extensibility, enabling the integration of different architectures, attention mechanisms, and training techniques to optimize the performance and efficiency of the all-binary model.

Exemplary pseudocode for an all-binary model using PyTorch may be found in APPENDIX A.

FIG. 1D is a block model illustrating an aspect of a system for providing a lightweight codeword model, a data post processor. The data post processor 130 receives the generated output from the all-binary model core 120 and applies a series of transformations and operations to adapt it to the desired format and characteristics. The post-processing system may include, but is not limited to an output formatter, a filtering and thresholding subsystem, an output validation and evaluation subsystem, and an error handling and anomaly detection subsystem.

An output formatter 131 is responsible for converting the generated output into a specific format required by the application or user. It applies formatting rules and conventions to enhance the readability, coherence, and usability of the generated output. For example, in the case of generated text, the output formatter 131 may apply capitalization, punctuation, or line breaks to improve the clarity and structure of the text. In the case of generated time series data, the output formatter 131 may convert the values into the desired unit of measurement or apply specific formatting conventions to ensure consistency with the expected output format.

A filtering and thresholding subsystem 132 applies specific criteria or thresholds to filter or select the most relevant or reliable generated outputs. It helps to refine the generated output based on predefined rules, constraints, or user preferences. For example, in a recommendation system, the filtering and thresholding subsystem 132 may filter out generated recommendations that fall below a certain relevance threshold or exclude items that have already been recommended to the user. This subsystem ensures that only the most pertinent and valuable outputs are presented to the user or passed on for further processing. In an embodiment directed to anomaly detection, filtering and thresholding subsystem 132 may filter out detections which fall below a certain relevance threshold or may exclude anomalies that are not outliers.

An output validation and evaluation subsystem 133 assesses the quality and performance of the generated output against predefined metrics or ground truth data. It applies validation techniques to ensure that the generated output meets the expected criteria and conforms to the desired characteristics. This subsystem may include automatic evaluation methods, such as calculating similarity scores, perplexity, or domain-specific metrics, to measure the accuracy, coherence, or effectiveness of the generated output. By continuously monitoring and evaluating the generated output, the output validation and evaluation subsystem 133 provides valuable insights for model improvement and fine-tuning.

An error handling and anomaly detection subsystem 134 identifies and handles any errors, anomalies, or unexpected patterns in the generated output. It incorporates techniques for detecting and correcting syntactic or semantic errors, identifying out-of-distribution samples, or flagging potential issues that require human intervention. This subsystem plays a critical role in maintaining the quality and reliability of the generated output by proactively identifying and addressing any problems or inconsistencies. It helps to prevent the propagation of errors downstream and ensures that the generated output is trustworthy and dependable.

In some embodiments, data post processor 130 may interface with a cloud-based system which can provide associated supporting data. For example, the cloud-based system can provide weather data on a high temperature day (at or above 90° F.) to data post processor which in turn can use this information when comparing all-binary model outputs to thresholds to determine anomalies in the sensor data. In this example, the sensors may be monitoring the operating temperature of various components of a combine harvester during its operation on the hot day. Due to the high ambient temperature, the sensor readings would also be increased which may exceed some threshold value. Instead of generating an alert for this anomalous reading, the system can use the weather data to dynamically change the threshold value so that the all-binary network isn't producing false positive results.

Data post processor 130 works seamlessly with the other components of the lightweight codeword model system to deliver high-quality and reliable generated outputs. It receives the generated output from all-binary core 120, which has learned the underlying patterns, relationships, and dependencies within the input data. The post-processing subsystems within data post processor 130 then refine, format, validate, and ensure the quality of the generated output, making it suitable for the intended application or user.

The specific configuration and parameters of each subsystem within data post processor 130 can be customized and adapted based on the requirements of the application domain and the nature of the generated output. The modular design of the post-processor allows for the integration of additional subsystems or the modification of existing ones to meet the specific needs of the task at hand.

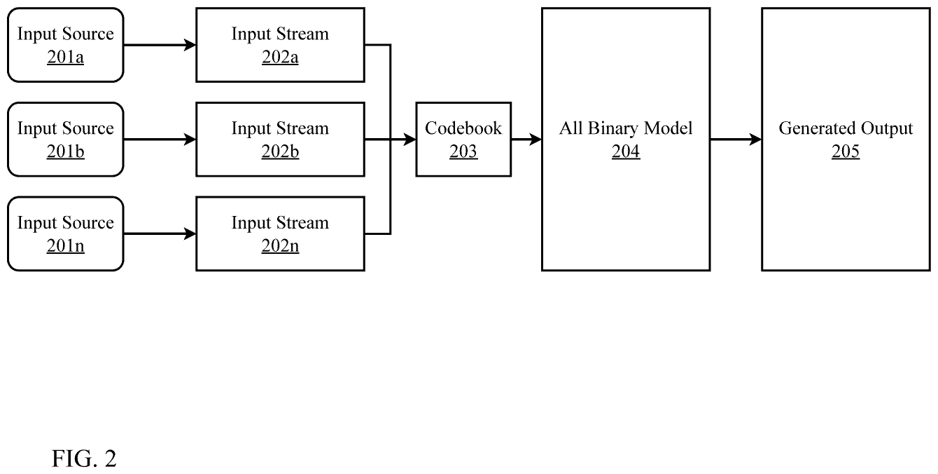

FIG. 2 is a block diagram illustrates an exemplary pipeline for processing a plurality of input streams from a plurality of input sources using an all-binary model, according to an embodiment. This embodiment illustrates a multi-source input processing system feeding into an all-binary model. According to the embodiment, the pipeline comprises a plurality of input sources 201a, 201b, and 201n. Input source 201a, input source 201b, and input source 201n represent different data sources, which could be various sensors or data streams in a complex system. Each source produces its own input stream 202a, 202b, and 202n which might be continuous, real-time data.

A single, shared codebook 203 is used to encode data from all input streams. This codebook may use deep learning or Huffman coding or a similar compression technique to assign binary codewords to frequently occurring patterns or values in the input data. Using a shared codebook ensures consistency in encoding across all input streams and potentially captures inter-stream relationships. In some embodiments, codebook 203 may be stored locally on the same device which stores and operates the all-binary model 204. In some embodiments, codebook 203 may be stored on a midserver which collects the plurality of data streams from the plurality of input sources. For example, the plurality of sensors on a combine harvester can send their sensor measurements to a midserver which can encode the sensor data into binary codewords which can be sent to the device which processes the codewords using the all-binary model. In another embodiment, codebook 203 may be stored in a cloud-based computing device which receives the plurality of sensor data.

Each input stream is processed through the shared codebook. The codebook converts the raw input data into a stream of codewords. These codewords are binary representations that efficiently encode the input data. The output of the encoding process is a set of codeword streams, one for each input source. These codeword streams are now in a binary format, suitable for the all-binary model. The codeword streams may be combined into vectors, where each vector represents a snapshot of data from all sources at a particular point in time. The size of the combined vector is based on and matches the number of deployed sensors associated with the complex system. For example, the vector may comprise [Codeword_A_t1, Codeword_B_t1, . . . , Codeword_n_t1], representing the codewords from all sources at time t1. A sequence of these vectors forms a time series, capturing the evolution of data form all sources over time.

This sequence of codeword vectors serves as the input to the all-binary model 204. The model receives a matrix wherein, for example, each row is a time step, and each column represents a different input source. The model, being all-binary, is designed to operate directly on these binary codeword inputs. In an embodiment, it starts with convolutional layers to process the time series data across all input streams simultaneously. Following layers (e.g., LSTM and fully connected layers) continue to process this binary data, maintaining the binary nature throughout the network. The model produces an output 205, still in binary form, which could represent classifications, predictions, or detected anomalies based on the multi-source input data.

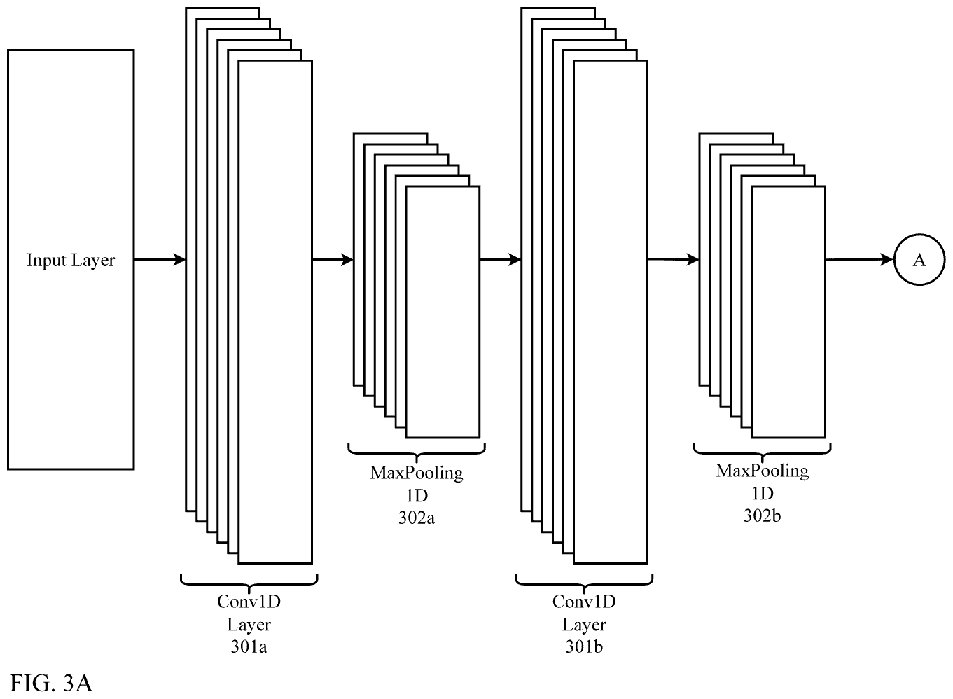

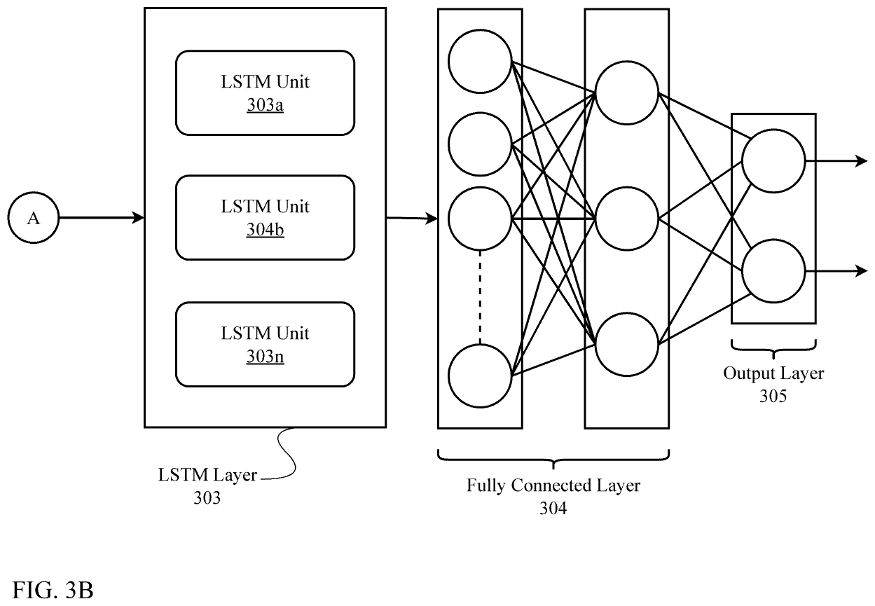

FIG. 3A is a block diagram illustrating an exemplary aspect of an all-binary model, the convolutional phase of the all-binary model. As shown, an input layer is present which receives an input to the convolutional layers of the all-binary model. According to an aspect, the binary convolutional layers may comprise binary weights, binary activation functions, and operations implemented using XNOR or popcount functions. Let's assume the input is a matrix of shape (T, N) where T is the number of time steps and N is the number of input sources (A, B, . . . , n). Each element in this matrix is a binary codeword representing the encoded value from a specific source at a specific time step. The convolutional phase may comprise a plurality of convolutional layers 301a-n and max pooling layers 302a-n. The convolutional layers can be implemented as 1D convolution layers. These layers slide a kernel (filter) across the time dimension for each input source. Each convolution operation performs binary operations (such as XNOR and popcount) instead of floating-point multiplication and addition. The convolution captures local patterns in the time series for each source. For each source, if there is a kernel of size K, it slides across T time steps, producing (T-K+1) outputs (assuming stride 1 and no padding).

The max pooling layers reduce the temporal dimension by selecting the maximum value in each pooling window. In the binary context, this may be implemented as a bitwise OR operation over the pooling window. If the pooling size is P, it reduces the temporal dimension by a factor of P.

The exemplary illustration shows two convolutional layers and two max pooling layers. An example walking through the convolutional phase of the all-binary model is provided. The initial input in this example is (T, N). The first convolution layer 301a has a kernel size of K1 and a number of filters F1. The output shape is (T-K1+1, N*F1). Each of the N input channels now has F1 feature maps. The first max pooling layer 302a has a pool size of P1. The output shape is ((T-K1+1)/P1, N*F1). The second convolution layer 301b has a kernel size of K2 and a number of filters F2. The output shape is (((T-K1+1)/P1)−K2+1, N*F1*F2). The second max pooling layer 302b has a pool size of P2. The output shape is ((((T-K1+1)/P1)−K2+1)/P2, N*F1*F2). The output of these layers is a 3D tensor with shape (Reduced_Time_Steps, N, F1*F2) where. Reduced_Time_Steps is the number of time steps after convolutions and pooling, N is still the number of input sources, and F1*F2 is the total number of features extracted per input source. Each time step in the output represents a higher-level feature extracted from a segment of the original time series. For each input source, there are now F1*F2 different features, each capturing different patterns in the data. The temporal dimension has been reduced, but the relationship between different time steps is preserved.

This output is still in a binary or quantized integer format, maintaining the all-binary nature of the model. It has effectively transformed the original time series of codewords into a more compact representation that captures temporal patterns across all input sources. This representation is then typically fed into subsequent layers of the model, such as LSTM layers or fully connected layers, for further processing and eventual output generation.

FIG. 3B is a block diagram illustrating an exemplary aspect of an all-binary model, the LSTM and FCN phase of the all-binary model. The output from the convolutional/max pooling layers may be a 3D tensor with shape (Reduced_Time_Steps, N, F), where Reduced_Time_Steps is the number of time steps after convolutions and pooling, N is the number of input sources, and F is the total number of features extracted per input source (F1*F2 from previous convolutions). The 3D tensor may be reshaped to (Reduced_Time_Steps, N*F) to create a sequence of feature vectors. Each LSTM 303 unit 303a, 303b, 303n processes this sequence step by step. For each time step, the LSTM takes a binary vector of size (N*F) as input. The LSTM maintains a binary cell state and hidden state. The forget, input, and output gates use binary weights and binary sigmoid activations. The cell state update uses binary tanh (or similar binary activation). All matrix multiplications are replaced with binary operations (e.g., XNOR and popcount). Each LSTM unit outputs a binary vector for each time step. If L number of LSTM units, the output shape is (Reduced_Time_Steps, L). If there are multiple LSTM layers, the output of one layer becomes the input to the next. The final LSTM layer's output is used for further processing. Each element in the LSTM output is a binary value representing some learned temporal feature.

Generally, the last output of the LSTM or flattened version of all outputs is used as input to the fully connected network 304. A series of binary fully connected layers process this input. Each layer performs binary matrix multiplication (e.g., using XNOR and popcount) followed by a binary activation function. If a layer has M input neurons and N output neurons: the input shape is (M,) the weight matrix is (N, M), and the output shape is (N,). The operation of the neuron may be represented as: output=binary_activation (binary_matmul(input, weights)).

The last fully connected layer 305 produces the final output of the model. The form of this output depends on the specific task. For binary classification, the output shape is (L) and may be a single binary value (0 or 1) representing the class. For multi-class classification the output shape is (num_classes) and may be a binary vector where each element represents a class and wherein the class with the highest value (or specific pattern) is chosen. For regression, the output shape is (output_dim) and may be a binary or quantized integer vector representing the predicted value(s). This might need to be de-quantized or decoded to get the final prediction. For anomaly detection, the output shape is (1,) or (2,) and may be a binary value indicating normal/anomaly, or quantized score representing the degree of anomaly.

The binary output from the output layer of the fully connected network is the model's final prediction or classification. This output maintains the all-binary nature of the model throughout the entire process, from the initial codeword inputs through the convolutional, LSTM, and fully connected layers. The binary output may then be interpreted based on the specific task requirements, potentially involving a decoding step to map the binary representation back to the original data space or decision criteria.

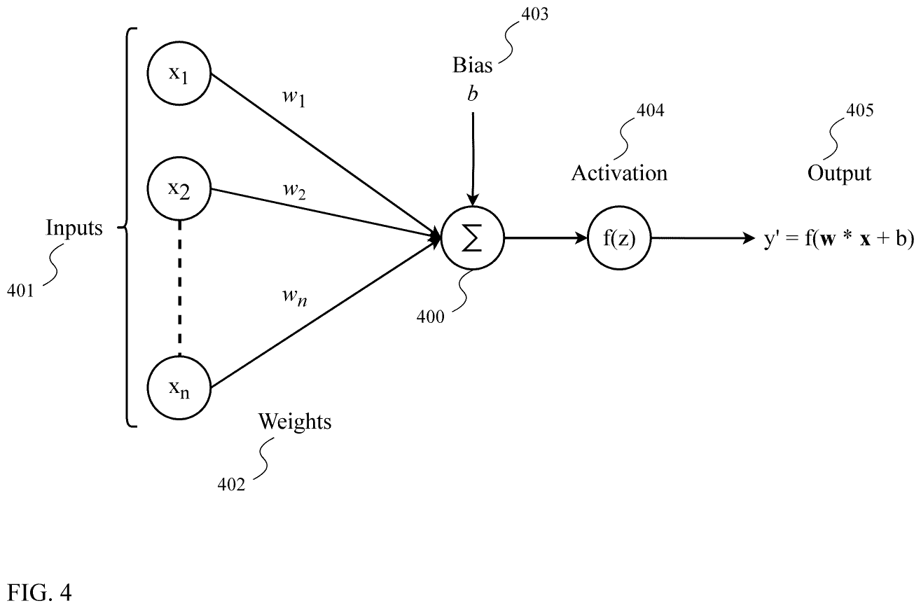

FIG. 4 is a diagram illustrating an exemplary neural network neuron, configured to operate as a binary neuron according to an embodiment. The neuron is a fundamental unit in artificial neural networks, often referred to as a perceptron in its simplest form. It models the basic functionality of a biological neuron, processing multiple inputs to produce a single output.

As shown, a plurality of inputs (x₁, x₂, . . . xₙ) 401 may feed into a single neuron 400. These represent the incoming signals from previous neurons or the initial input layer. Each xᵢ is typically a real number. For example, x₁=0.5 (representing a moderate activation from a previous neuron), x₂=−0.2 (representing a slight inhibition), and xₙ=0.8 (representing a strong activation). Each neuron in the network also have at least one associated weight parameter (w₁, w₂, wₙ) 402. Weights are learnable parameters that scale the importance of each input. They are also real numbers, positive or negative. For instance, w₁=0.3, w₂=−0.1, wₙ=0.6. Negative weights represent inhibitory connections, while positive weights are excitatory. The bias (b) 403 is an additional learnable parameter that shifts the neuron's activation. It's equivalent to adding a constant input of 1 with its own weight.

The neuron 400 computes the sum of weighted inputs plus the bias:

$$z = ( {x}_{1} * {w}_{1} ) + ( {x}_{2} * {w}_{2} ) + ( {x}_{n} * {w}_{n} ) + b$$

Using the example values:

$$z = ( 0.5 * 0.3 ) + ( - 0.2 * - 0.1 ) + ( 0.8 * 0.6 ) + ( - 0.2 ) = 0.15 + 0.02 + 0 \text{.48} - 0.2 = 0.45$$

The weighted sum z is passed through an activation function f(z) 404 to produce the output y′ 405.

Common activation functions that may be implemented in various embodiments include, but are not limited to:

Sigmoid: f(z)=1/(1+e\hat{ }(−z)) with an output range of (0, 1). Using the previously computed value of z: f(0.45)≈0.6108.

ReLU (Rectified Linear Unit): f(z)=max(0, z) with an output range: of [0, ∞). Using the previously computed value of z: f(0.45)=0.45.

Tanh: f(z)=(e\hat{ }z−e\hat{ }(−z))/(e\hat{ }z+e\hat{ }(−z)) with an output range of (−1, 1). Using the previously computed value of z: f(0.45)≈0.4219.

Leaky ReLU: f(z)=max(0.01z, z) which addresses the “dying ReLU” problem. Using the previously computed value of z: f(0.45)=0.45, f(−0.45)=−0.0045.

The choice of activation function depends on the specific requirements of the network and the problem being solved. The final output y′ is the result of applying the activation function to z. This output can then serve as an input to neurons in the subsequent layer. During training, the weights and bias are adjusted to minimize the difference between the neuron's output and the desired output. This is typically done through backpropagation and gradient descent algorithms.

The entire process can be succinctly represented in vector notation:

$${y}^{′} = f ( \overline{W} \hat{} T * \overline{X} + b )$$

Where W is the weight vector [w₁, w₂, . . . , wₙ], X is the input vector [x₁, x₂, . . . , xₙ], and W\hat{ }T represents the transpose of W. This neuron, when combined with many others in multiple layers, forms the basis of deep neural networks capable of learning complex patterns and representations in data.

According to an embodiment, a neural network may be implemented as a binary neural network (e.g., all-binary core) using binary number weights, binary activation functions, and binary matrix multiplications using, for example, XNOR and popcount functions. The binary neural network may receive at the input layer one or more codewords (such as those generated using a codebook). In an embodiment, the weights of the neurons in the binary neural network are constrained to integer values only. The neuron weights may be implemented using any number of bits. For example, the neuron weights can be implemented as 8-bit integers ranging from −128 to +127. This approach combines binary inputs with more nuanced, quantized weights. The inputs (x₁, x₂, . . . , xₙ) are codewords. Weights (w₁, w₂, . . . , wₙ) are initialized and stored as 8-bit integers (−128 to 127). Each weight can be represented by 8 bits (or any number of bits). Example weights: [64, −32, 96, −128, 127]. According to an aspect, weight updates during training may be quantized to maintain the 8-bit integer format. Bias (b) may also be implemented as an 8-bit signed integer, for example, b=−15. The weighted sum is now an integer operation which simplifies the process by decreasing the total compute time for each computation (which is dependent upon the size of the neural network).

$$z = ( {x}_{1} * {w}_{1} ) + ( {x}_{2} * {w}_{2} ) + … + ( {x}_{n} * {w}_{n} ) + b$$

Using the previous examples:

$$z = ( 1 * 64 ) + ( 0 * - 32 ) + ( 1 * 96 ) + ( 1 * - 128 ) + ( 0 * 127 ) + ( - 15 ) = 64 + 0 + 96 - 128 - 15 = 17$$

The activation function may be adapted for integer inputs. Some options include:

Step Function: f(z)=1 if z>0, else 0. Using the previously computed value of z: f(17)=1

ReLU (adapted): f(z)=max(0, z). Using the previously computed value of z: f(17)=17

Quantized Sigmoid which maps the integer input to a small set of output values. For example, the system could define:

$$f ( z ) = 0 if z < - 128$$

$$1 if z > 127$$

$$( z + 1 \; 28 ) / 256 otherwise ( rounded to nearest 1 / 16 )$$

Using the previously computed value of z: f(17)≈0.5625 (9/16).

The output depends on the chosen activation function. Using the quantized sigmoid: z

$${y}^{′} = f ( 17 ) \approx 0.5625$$

The training process of the all-binary model which utilizes binary neurons may be adapted to facilitate the all binary nature of the neural network. For instance, gradient descent can be adapted to handle discrete weight updates. One possible approach is to accumulate fractional updates and apply them when they exceed a threshold.

This redesigned model maintains the binary nature of the inputs while introducing more nuanced, quantized weights. It represents a compromise between the simplicity of binary weights and the flexibility of floating-point weights, potentially offering advantages in terms of memory efficiency and computational simplicity at the cost of some precision.

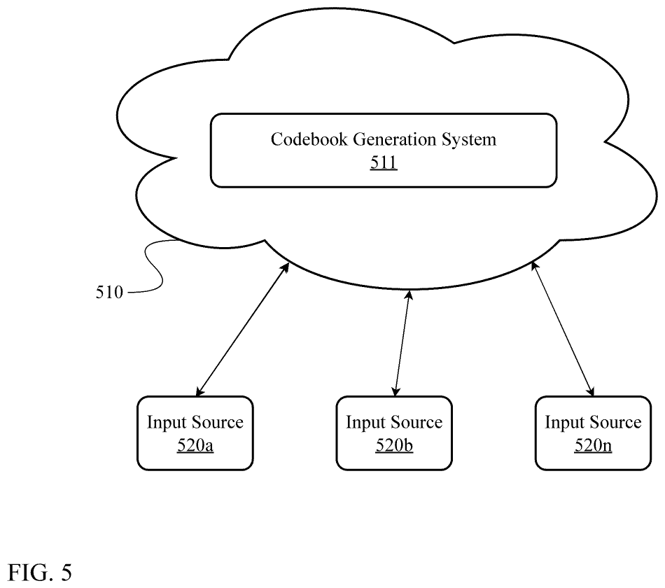

FIG. 5 is a block diagram illustrating a codebook generation system configured to operate in a cloud-based environment and create a shared codebook from a plurality of input sources associated with a complex system. As shown, a plurality of input sources 520a, 520b, 520n may be present and configured to send their respective data streams to a cloud-based computing device 510 (e.g., server(s)) which acts as a central processing hub for the plurality of input sources. In an embodiment, the input sources are implemented as a plurality of sensors (e.g., sensor array) associated with a complex system (e.g., machine, process, etc.). The input streams may comprise a plurality of time-series sensor measurements values. In some embodiments, the input sources 520a-n may send their input streams to an intermediate computing device which may be configured to collect the sensor data and then the intermediate computing device can transmit the plurality of sensor data to the cloud-based computing device.

At the cloud-based computing device, a codebook generation system 511 is present and configured to receive a plurality of input streams from a plurality of input sources and to create a shared codebook which can be used to encode the input data streams. In some embodiments, codebook generation system 511 may employ Huffman coding to create the codebook. In other embodiments, codebook generation system 511 may employ a deep learning network (e.g., autoencoder) configured to create encoded representations of the input data as a form of codebook.

In some embodiments, the created codebook may utilized by a computing device associated with a complex system to encode obtained input streams from the plurality of input sources. The codebook can be stored locally on the computing device. The codebook can be kept in the cloud for cloud-based processing. In some embodiments, the computing device associated with the complex system stores and operates an instance of the created, shared codebook and an instance of the all-binary model. In such embodiments, the computing device can receive a plurality of input data streams, encode the input streams using the stored codebook, and feed the codewords into the all-binary model to generate model outputs which can be used for classification, regression, and/or anomaly detection purposes.

In an embodiment, codebook generation system 511 may implement monitoring and update mechanisms. A first such mechanism may involve statistical analysis wherein the system continuously calculates entropy and information content of incoming data, monitors symbol frequencies and distribution changes, and tracks compression ratios achieved with the current codebook. In some implementations, the system may employ algorithms to detect significant shifts in data patterns. This may use techniques like cumulative sum control chart (CUSUM) or exponentially weighted moving average (EWMA) to identify trend changes. The system may be further configured to analyze performance metrics. For instance, the system can monitor encoding/decoding speed, track memory usage of the codebook, and measure overall system latency. The system may also perform periodic retraining at regular intervals, wherein the interval can be adjusted based on the rate of change in the data stream. The system may also perform trigger-based updates by setting thresholds for key metrics (e.g., compression ratio, entropy change, etc.) to initiate codebook updates when thresholds are exceeded. In some embodiments, cloud-based computing device 510 collects performance data form encoding/decoding operations and uses this feedback to inform codebook update decisions.

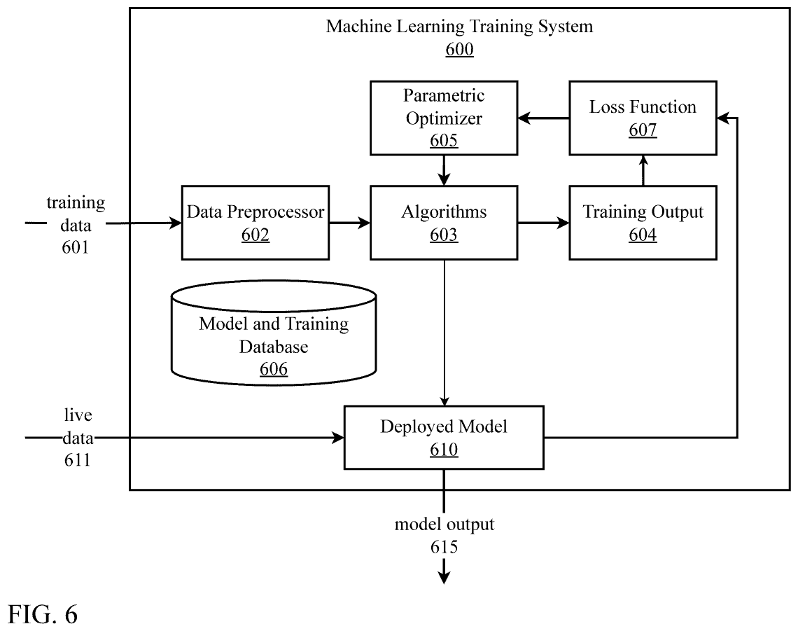

FIG. 6 is a block diagram illustrating an aspect of a system for providing an all-binary model core for a lightweight codeword model, a machine learning training system. According to the embodiment, the machine learning training system 600 may comprise a model training stage comprising a data preprocessor 602, one or more machine and/or deep learning algorithms 603, training output 604, and a parametric optimizer 605, and a model deployment stage comprising a deployed and fully trained model 610 configured to perform tasks described herein such as processing codewords through an all-binary lightweight codeword model. The machine learning training system 600 may be used to train and deploy a plurality of machine learning architectures in order to support the functioning of the all-binary model. In one embodiment, machine learning training system 600 may be used to train the convolutional layers 155, the LSTM layers 160, and the fully connected network 165. The machine learning training system 600 may train each of the proceeding systems separately or together as a single end-to-end system.

At the model training stage, a plurality of training data 601 may be received by the generative AI training system 650. Data preprocessor 602 may receive the input data (e.g., codeword vector inputs, latent space vector representations) and perform various data preprocessing tasks on the input data to format the data for further processing. For example, data preprocessing can include, but is not limited to, tasks related to data cleansing, data deduplication, data normalization, data transformation, handling missing values, feature extraction and selection, mismatch handling, and/or the like. Data preprocessor 602 may also be configured to create training dataset, a validation dataset, and a test set from the plurality of input data 601. For example, a training dataset may comprise 80% of the preprocessed input data, the validation set 10%, and the test dataset may comprise the remaining 10% of the data. The preprocessed training dataset may be fed as input into one or more machine and/or deep learning algorithms 603 to train an all-binary model core.

During model training, training output 604 is produced and used to measure the accuracy and usefulness of the predictive outputs. During this process a parametric optimizer 605 may be used to perform algorithmic tuning between model training iterations. Model parameters and hyperparameters can include, but are not limited to, bias, train-test split ratio, learning rate in optimization algorithms (e.g., gradient descent), choice of optimization algorithm (e.g., gradient descent, stochastic gradient descent, of Adam optimizer, etc.), choice of activation function in a neural network layer (e.g., Sigmoid, ReLu, Step (binary), Tanh, etc.), the choice of cost or loss function the model will use, number of hidden layers in a neural network, number of activation unites in each layer, the drop-out rate in a neural network, number of iterations (epochs) in a training the model, number of clusters in a clustering task, kernel or filter size in convolutional layers, pooling size, batch size, the coefficients (or weights) of linear or logistic regression models, cluster centroids, and/or the like. Parameters and hyperparameters may be tuned and then applied to the next round of model training. In this way, the training stage provides a machine learning training loop.

In some implementations, various accuracy metrics may be used by the machine learning training system 600 to evaluate a model's performance. Metrics can include, but are not limited to, word error rate (WER), word information loss, speaker identification accuracy (e.g., single stream with multiple speakers), inverse text normalization and normalization error rate, punctuation accuracy, timestamp accuracy, latency, resource consumption, custom vocabulary, sentence-level sentiment analysis, multiple languages supported, cost-to-performance tradeoff, and personal identifying information/payment card industry redaction, to name a few. In one embodiment, the system may utilize a loss function 607 to measure the system's performance. The loss function 607 compares the training outputs with an expected output and determines how the algorithm needs to change in order to improve the quality of the model output. During the training stage, all outputs may be passed through the loss function 607 on a continuous loop until the algorithms 603 are in a position where they can effectively be incorporated into a deployed model 610.

The test dataset can be used to test the accuracy of the model outputs. If the training model is establishing correlations that satisfy a certain criterion such as but not limited to quality of the correlations and amount of restored lost data, then it can be moved to the model deployment stage as a fully trained and deployed model 610 in a production environment making predictions based on live input data 611 (e.g., codeword vector inputs, latent space vector representations, encoded time-series sensor readings, etc.). Further, model correlations and restorations made by deployed model 610 can be used as feedback and applied to model training in the training stage, wherein the model is continuously learning over time using both training data and live data and predictions. A model and training database 606 is present and configured to store training/test datasets and developed models. Database 606 may also store previous versions of models.

According to some embodiments, the one or more machine and/or deep learning models may comprise any suitable algorithm known to those with skill in the art including, but not limited to: LLMs, generative transformers, transformers, supervised learning algorithms such as: regression (e.g., linear, polynomial, logistic, etc.), decision tree, random forest, k-nearest neighbor, support vector machines, Naïve-Bayes algorithm; unsupervised learning algorithms such as clustering algorithms, hidden Markov models, singular value decomposition, and/or the like. Alternatively, or additionally, algorithms 603 may comprise a deep learning algorithm such as neural networks (e.g., recurrent, convolutional, long short-term memory networks, fully connected networks, autoencoders, etc.).

In some implementations, the machine learning training system 600 automatically generates standardized model scorecards for each model produced to provide rapid insights into the model and training data, maintain model provenance, and track performance over time. These model scorecards provide insights into model framework(s) used, training data, training data specifications such as chip size, stride, data splits, baseline hyperparameters, and other factors. Model scorecards may be stored in database(s) 606.

According to an embodiment, machine learning training system 600 can train the all-binary model by initializing binary weights for the neural network layers, forward propagating binary codewords through the network while maintaining binary representations, computing a loss function based on the network's binary output, back-propagating errors through the network using binary approximations of gradients, and updating binary weights using a binary optimization algorithm.

### Detailed Description of Exemplary Aspects

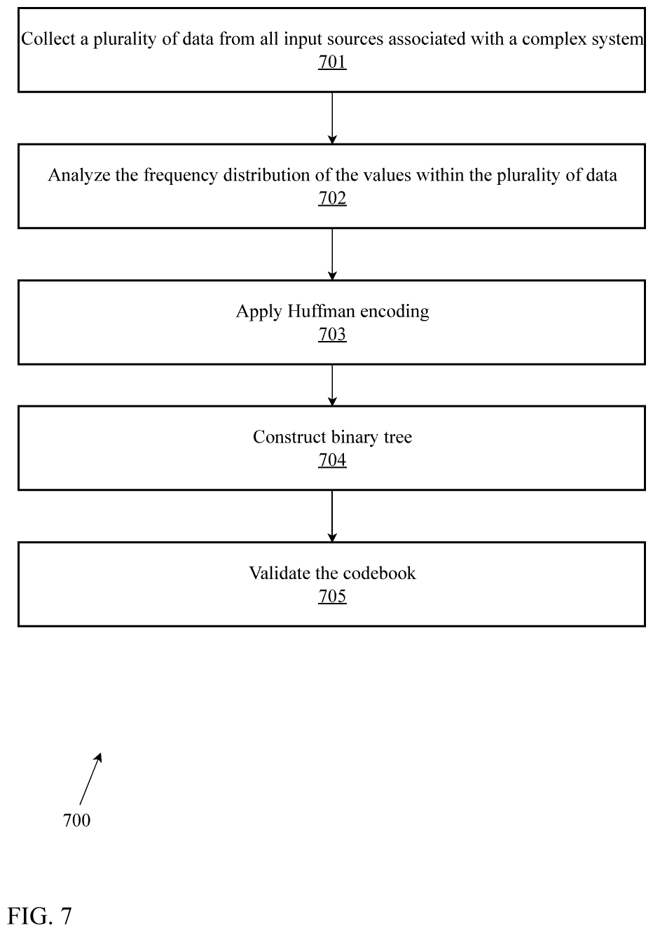

FIG. 7 is a flow diagram illustrating an exemplary method 700 for creating a shared codebook for encoding input data streams into a codeword stream, according to an aspect. According to the aspect, the process begins at step 701 with collecting a representative dataset from all input sources that will be processed by the all-binary model. This dataset should encompass the full range of values and patterns expected in the input streams. At step 702, the method analyzes the frequency distribution of values within this dataset, identifying common patterns and recurring values across all input sources. Based on this analysis, a Huffman coding algorithm is applied at step 703 to assign shorter binary codes to more frequent values and longer codes to less frequent ones, optimizing for overall compression efficiency. The method then constructs a balanced binary tree structure at step 704, where each leaf node represents a unique input value and its path from the root node defines its binary codeword. To handle continuous or floating-point data, the method may implement a quantization step that discretizes the input space into a finite number of bins, with each bin then assigned a unique binary codeword. The codebook is further refined by incorporating domain-specific knowledge to ensure that critical value ranges or patterns are adequately represented, even if they occur infrequently in the training dataset. To manage codebook size and maintain efficiency, the method employs a pruning technique that removes or combines rarely used codewords while ensuring minimal information loss. Finally, the method includes a validation step 705 where the codebook is tested on a separate dataset to ensure it provides efficient and accurate encoding across all input sources. The resulting shared codebook is then integrated into the encoding module of the all-binary neural network system, enabling consistent and efficient binary representation of inputs from all sources.

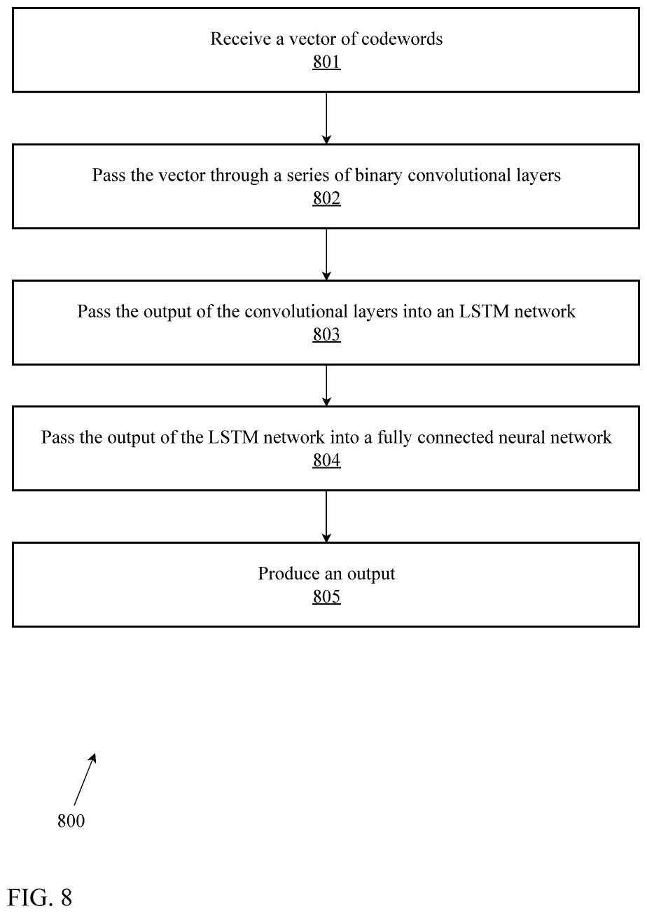

FIG. 8 is a flow diagram illustrating an exemplary method 800 for processing a vector of codewords using an all-binary model, according to an aspect. According to the aspect, the process begins at step 801 with the input of a vector containing binary codewords, each representing encoded data from multiple sources. This vector is first passed through a series of binary convolutional layers, where binary kernels slide across the input, performing XNOR operations followed by popcount functions to simulate convolution at step 802. These operations extract hierarchical features from the input while maintaining the binary nature of the data. After each convolutional layer, a binary activation function is applied, which may be implemented as a simple threshold operation. To reduce spatial dimensions and enhance feature invariance, binary max pooling layers can be interspersed among the convolutional layers, selecting the maximum value (represented as ‘1’ in binary) within each pooling window. The output from the convolutional and pooling layers is then fed into one or more binary LSTM layers to capture temporal dependencies in the data at step 803. Within these LSTM layers, binary gates (input, forget, and output) are implemented using XNOR and popcount operations, and the cell state is maintained in a binary format. The binary LSTM processes the sequence of binary vectors, updating its internal state and producing an output at each time step, all while maintaining binary representations. Following the LSTM layers, the processed binary data is passed through a series of binary fully connected layers at step 804. These layers can perform binary matrix multiplications, again using XNOR and popcount operations, followed by binary activation functions. At step 805, the final layer of the network produces the output, which remains in a binary format. This output can represent a classification, a prediction, or an anomaly detection result, depending on the specific application of the model. Throughout this entire process, all internal representations, weights, and operations remain in a binary format, enabling efficient computation and reduced memory usage while effectively capturing complex patterns in the input data.

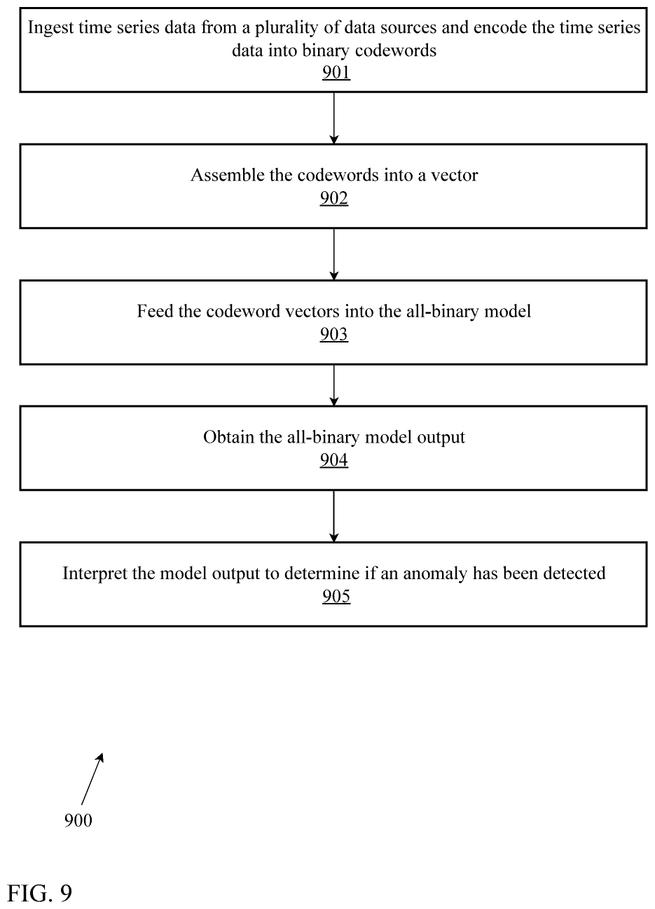

FIG. 9 is a flow diagram illustrating an exemplary method 900 for anomaly detection using an all-binary model, according to an aspect. According to the aspect, the process begins at step 901 with the continuous ingestion of multi-source time series data, which is immediately encoded into binary codewords using the shared codebook. These binary codewords are assembled into vectors at step 902, each representing a snapshot of the system state across all data sources at a given time point. At step 903 the vectors are fed into the all-binary neural network, starting with the binary convolutional layers. These layers, which may use XNOR and popcount operations, extract relevant features from the input data, effectively learning to identify normal patterns and potential anomalies in the binary representation. The processed data then flows through binary max pooling layers, which help to reduce dimensionality while preserving key features. Next, the binary LSTM layers process the sequence of binary vectors, capturing temporal dependencies and long-term patterns in the data. This temporal processing is important for identifying anomalies that manifest over time rather than in isolated instances. The LSTM layers, maintaining binary cell states and using binary gates, learn to recognize normal temporal progressions in the data and flag deviations from these patterns. Following the LSTM layers, binary fully connected layers further process the data, combining information across all sources and time steps to make a final determination at step 904. The output layer of the network produces a binary anomaly indicator, where ‘1’ might indicate the presence of an anomaly and ‘0’ the absence. To handle varying degrees of anomaly severity, the model can be designed to output multiple binary digits, allowing for a more nuanced representation of anomaly likelihood or severity. The binary nature of the entire process, from input encoding to final output, ensures computational efficiency and low latency, making it suitable for real-time anomaly detection in resource-constrained environments. The model's performance is continually evaluated, and its binary weights are periodically updated using specialized training techniques that maintain the binary constraint, allowing the system to adapt to evolving patterns in the data and refine its anomaly detection capabilities over time. At step 905 the system interprets the all-binary model output to determine if an anomaly has occurred.

If an anomaly is detected by the all-binary model, the system may initiate a series of automated responses and actions. Upon detecting an anomaly, the system could immediately trigger an alert protocol, notifying relevant personnel through various channels such as email, SMS, or a dedicated monitoring dashboard. The binary nature of the output allows for quick, low-latency notifications. The system could then automatically initiate a more detailed analysis of the anomalous data, potentially activating additional, more computationally intensive models to provide a deeper investigation into the nature and severity of the anomaly. This could involve temporarily increasing the sampling rate or resolution of data collection from the affected sources to gather more information.

The system might also implement automatic mitigation strategies, such as isolating affected components or adjusting operational parameters to prevent potential cascading failures. It could retrieve and present historical data of similar anomalies, along with their resolutions, to assist human operators in decision-making. In critical scenarios, the system could be programmed to automatically execute predefined safety protocols or shutdown procedures to prevent damage or ensure safety.

Additionally, the anomaly detection could trigger an automatic logging and archiving process, storing relevant data for future analysis and model improvement. The system could also initiate a self-diagnostic routine to ensure that the anomaly is not due to a malfunction in the monitoring system itself. In a learning capacity, the detected anomaly and subsequent actions could be used to update and refine the model's parameters, improving its future detection capabilities.

For less severe anomalies, the system might implement a “watch mode,” increasing the frequency of checks on the affected area without necessarily triggering a full alert. It could also cross-reference the anomaly with external data sources, such as weather conditions or scheduled maintenance activities, to provide context for the detected irregularity.

In a networked environment, the system could communicate the anomaly detection to other related systems or nodes, enabling a coordinated response to potential widespread issues. Finally, the system could generate a detailed report of the anomaly, including its binary representation, the specific patterns that triggered the detection, and a timeline of system responses, providing valuable documentation for future reference and system audits.

### Exemplary Computing Environment

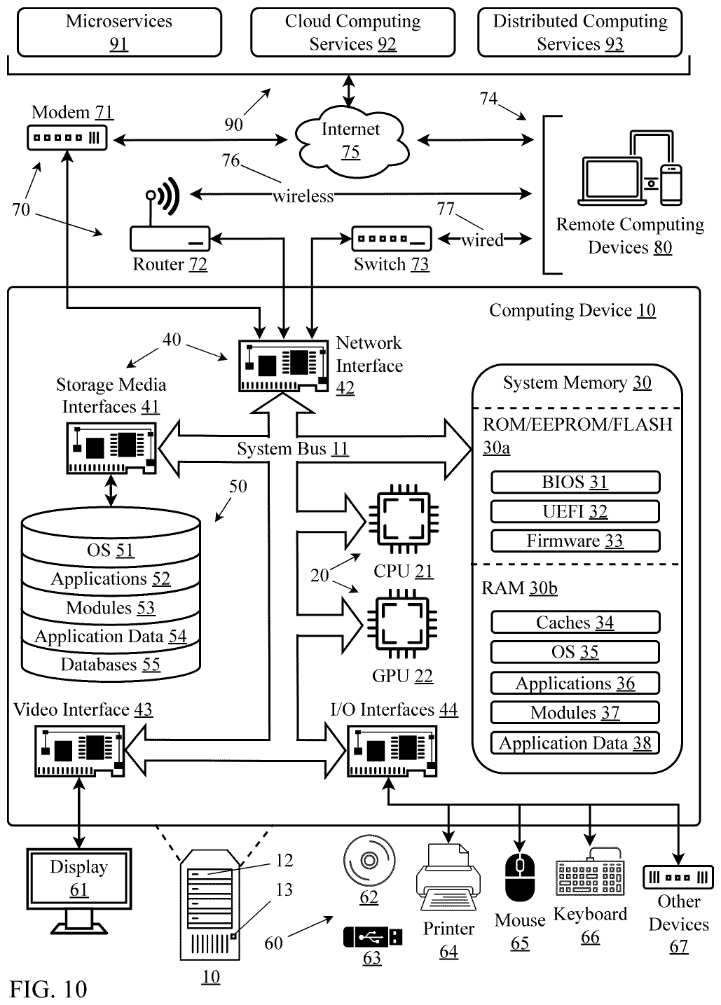

FIG. 10 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogencous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like Docker and container orchestration systems like Kubernetes, is a common approach for deploying and managing applications. Containers are created from images, which are lightweight, standalone, and executable packages that include application code, libraries, dependencies, and runtime. Images are often built from a Dockerfile or similar, which contains instructions for assembling the image. Dockerfiles are configuration files that specify how to build a Docker image. Systems like Kubernetes also support containerd or CRI-O. They include commands for installing dependencies, copying files, setting environment variables, and defining runtime configurations. Docker images are stored in repositories, which can be public or private. Docker Hub is an exemplary public registry, and organizations often set up private registries for security and version control using tools such as Hub, JFrog Artifactory and Bintray, Gitlab, Github Packages or Container registries. Containers can communicate with each other and the external world through networking. Docker provides a bridge network by default, but can be used with custom networks. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerd resources is used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

APPENDIX A
EXEMPLARY PSEUDOCODE FOR AN ALL-
BINARY NEURAL NETWORK USING PYTORCH

```
python
import torch
import torch.nn as nn
import torch.optim as optim
from torch.utils.data import DataLoader, TensorDataset
class BinaryNumberLinear(nn.Module):
  def _{——}init_{——}(self, in_features, out_features):
    super(BinaryNumberLinear, self)._{——}init_{——}( )
    self.in_features = in_features
    self.out_features = out_features
    self.weight = nn.Parameter(torch.randint(−128, 128, (out_features, in_features),
dtype=torch.int8))
    self.bias = nn.Parameter(torch.randint(−128, 128, (out_features,), dtype=torch.int8))
  def forward(self, input):
    # Convert input codewords to integers
    input_int = input.to(torch.int16)
    # Perform binary multiplication and addition
    output = torch.matmul(input_int, self.weight.t( ).to(torch.int16)) + self.bias.to(torch.int16)
    # Apply fixed-point scaling and clipping
    return torch.clamp(output >> 7, −128, 127).to(torch.int8)
class BinaryNumberLSTM(nn.Module):
  def _{——}init_{——}(self, input_size, hidden_size):
    super(BinaryNumberLSTM, self)._{——}init_{——}( )
    self.hidden_size = hidden_size
    self.input_gate = BinaryNumberLinear(input_size + hidden_size, hidden_size)
    self.forget_gate = BinaryNumberLinear(input_size + hidden_size, hidden_size)
    self.cell_gate = BinaryNumberLinear(input_size + hidden_size, hidden_size)
    self.output_gate = BinaryNumberLinear(input_size + hidden_size, hidden_size)
  def forward(self, input, hidden):
    h, c = hidden
    combined = torch.cat((input, h), dim=1)
    i = torch.sigmoid(self.input_gate(combined).float( ) / 128)
    f = torch.sigmoid(self.forget_gate(combined).float( ) / 128)
    o = torch.sigmoid(self.output_gate(combined).float( ) / 128)
    g = torch.tanh(self.cell_gate(combined).float( ) / 128)
    c = (f * c.float( ) + i * g) * 128
    h = (o * torch.tanh(c.float( ) / 128)) * 128
    return h.to(torch.int8), (h.to(torch.int8), c.to(torch.int8))
class BinaryNumberCodewordModel(nn.Module):
  def _{——}init_{——}(self, input_size, hidden_size, num_classes):
    super(BinaryNumberCodewordModel, self)._{——}init_{——}( )
    self.conv = nn.Conv1d(input_size, hidden_size, kernel_size=3, padding=1, bias=False)
    self.conv.weight.data = torch.randint(−128, 128, self.conv.weight.shape, dtype=torch.int8)
    self.lstm = BinaryNumberLSTM(hidden_size, hidden_size)
    self.fc = BinaryNumberLinear(hidden_size, num_classes)
  def forward(self, x):
    # x shape: (batch_size, sequence_length, input_size)
    x = x.transpose(1, 2) # (batch_size, input_size, sequence_length)
    x = self.conv(x.float( )).to(torch.int8)
    x = x.transpose(1, 2) # (batch_size, sequence_length, hidden_size)
    h = torch.zeros(x.size(0), self.lstm.hidden_size, dtype=torch.int8).to(x.device)
    c = torch.zeros(x.size(0), self.lstm.hidden_size, dtype=torch.int8).to(x.device)
    for t in range(x.size(1)):
      h, (h, c) = self.lstm(x[:, t, :], (h, c))
    x = self.fc(h)
    return x.float( ) # Convert to float for loss computation
# Hyperparameters
input_size = 64
hidden_size = 128
num_classes = 2 # Normal vs Unusual
sequence_length = 10
batch_size = 32
epochs = 10
# Create dummy dataset (binary codewords)
num_samples = 1000
X = torch.randint(0, 2, (num_samples, sequence_length, input_size), dtype=torch.uint8)
y = torch.randint(0, num_classes, (num_samples,))
dataset = TensorDataset(X, y)
dataloader = DataLoader(dataset, batch_size=batch_size, shuffle=True)
# Initialize model, loss, and optimizer
model = BinaryNumberCodewordModel(input_size, hidden_size, num_classes)
criterion = nn.CrossEntropyLoss( )
optimizer = optim.Adam(model.parameters( ))
# Training loop
for epoch in range(epochs):
  for batch_X, batch_y in dataloader:
    optimizer.zero_grad( )
    outputs = model(batch_X)
    loss = criterion(outputs, batch_y)
    loss.backward( )
    # Quantize gradients and clip weights to int8 range
    for param in model.parameters( ):
      if param.grad is not None:
        param.grad.data = torch.round(param.grad.data * 128) / 128
        param.data.clamp_(−128, 127)
    optimizer.step( )
  print(f”Epoch {epoch+1}/{epochs}, Loss: {loss.item( ):.4f}”)
# Inference
model.eval( )
with torch.no_grad( ):
  test_input = torch.randint(0, 2, (1, sequence_length, input_size), dtype=torch.uint8)
  prediction = model(test_input)
  print(“Prediction:”, torch.argmax(prediction, dim=1).item( ))
```

1. A system for processing data using an all-binary neural network, comprising:
a computing device comprising at least a memory and a processor:
an all-binary core comprising a first plurality of programming instructions stored in the memory and operable on the processor, wherein the first plurality of programming instructions, when operating on the processor, cause the computing device to:
encode input data into binary codewords;
process the binary codewords through a plurality of binary neural network layers;
generate a final output using the processed binary codewords; and
maintain binary representations and operations throughout the neural network.

2. The system of claim 1, wherein encoding input data into binary codewords comprises using a shared codebook.

3. The system of claim 2, wherein the shared codebook uses Huffman coding to generate binary codewords for input data values.

4. The system of claim 1, wherein the plurality of binary neural network layers comprises one or more binary convolutional layers.

5. The system of claim 4, wherein the binary convolutional layers comprise:
binary weights;
binary activation functions; and
operations implemented using XNOR and popcount functions.

6. The system of claim 4, further comprising a binary max pooling layer following at least one of the binary convolutional layers.

7. The system of claim 1, wherein the plurality of binary neural network layers comprises one or more binary long short-term memory (LSTM) layers.

8. The system of claim 7, wherein the binary LSTM layers comprise:
binary input, forget, and output gates;
a binary cell state; and
binary matrix multiplications implemented using XNOR and popcount functions.

9. The system of claim 1, wherein the plurality of binary neural network layers comprises one or more binary fully connected layers.

10. The system of claim 9, wherein the binary fully connected layers comprise:
binary weights;
binary activation functions; and
binary matrix multiplications implemented using XNOR and popcount functions.

11. The system of claim 1, wherein the input data comprises multi-source time series data.

12. The system of claim 1, wherein the final output comprises a binary anomaly indicator.

13. The system of claim 1, wherein the one or more hardware processors are further configured for training the all-binary neural network by:
initializing binary weights for the neural network layers;
forward propagating binary codewords through the network while maintaining binary representations;
computing a loss function based on the network's binary output;
back-propagating errors through the network using binary approximations of gradients; and
updating binary weights using a binary optimization algorithm.

14. The system of claim 1, wherein the one or more hardware processors are further configured for quantizing floating-point values to binary or n-bit integer representations.

15. The system of claim 1, wherein the all-binary neural network is implemented on an edge computing device with limited computational and memory resources.

16. A method for processing data using an all-binary neural network, comprising the steps of:
encoding input data into binary codewords;
processing the binary codewords through a plurality of binary neural network layers;
generating a final output using the processed binary codewords; and
maintaining binary representations and operations throughout the neural network.

17. The method of claim 16, wherein encoding input data into binary codewords comprises using a shared codebook.

18. The method of claim 17, wherein the shared codebook uses Huffman coding to generate binary codewords for input data values.

19. The method of claim 16, wherein the plurality of binary neural network layers comprises one or more binary convolutional layers.

20. The method of claim 19, wherein the binary convolutional layers comprise:
binary weights;
binary activation functions; and
operations implemented using XNOR and popcount functions.

21. The method of claim 19, further comprising a binary max pooling layer following at least one of the binary convolutional layers.

22. The method of claim 16, wherein the plurality of binary neural network layers comprises one or more binary long short-term memory (LSTM) layers.

23. The method of claim 22, wherein the binary LSTM layers comprise:
binary input, forget, and output gates;
a binary cell state; and
binary matrix multiplications implemented using XNOR and popcount functions.

24. The method of claim 16, wherein the plurality of binary neural network layers comprises one or more binary fully connected layers.

25. The method of claim 24, wherein the binary fully connected layers comprise:
binary weights;
binary activation functions; and
binary matrix multiplications implemented using XNOR and popcount functions.

26. The method of claim 16, wherein the input data comprises multi-source time series data.

27. The method of claim 16, wherein the final output comprises a binary anomaly indicator.

28. The method of claim 16, further comprising the step of training the all-binary neural network by:
initializing binary weights for the neural network layers;
forward propagating binary codewords through the network while maintaining binary representations;
computing a loss function based on the network's binary output;
back-propagating errors through the network using binary approximations of gradients; and
updating binary weights using a binary optimization algorithm.

29. The method of claim 16, further comprising the step of quantizing floating-point values to binary or n-bit integer representations.

30. The method of claim 16, wherein the all-binary neural network is implemented on an edge computing device with limited computational and memory resources.
